(19) United States
(12) Patent Application Publication
(10) Pub. No.: US 2006/0192762 A1
(43) Pub. Date: Aug. 31, 2006

(54) Multi-function optical input device

(76) Inventor: Bradley W. Corrion, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/069,880

(22) Filed: Feb. 28, 2005

(51) Int. Cl. G09G 5/08

(52) U.S. Cl. 345/166

(57) ABSTRACT

In some embodiments, an input device includes a multi-function optical input device including, for example, traditional mouse functions, barcode reading functions, and/or optical character reading functions. Other embodiments are disclosed and claimed.

The invention relates to input devices and more particularly to multi-function input devices and methods of operating input devices.

### BACKGROUND AND RELATED ART

Optical mice are ubiquitous and well known. An optical mouse converts optical information into X-Y cursor movement data. Optical barcode readers are also ubiquitous and well known. An optical barcode reader converts optical information into decoded barcode data. Optical character readers are also well known in the art. An optical character reader converts optical information into decoded character information. U.S. Pat, No. 6,337,919 describes a fingerprint detecting mouse including an optical scanner. U.S. Pat. No. 6,422,775 describes a digital messaging pen including an optical character reader. U.S. Pat. No. 6,473,070 describes a wireless input device which may include infrared (IR) sensors and/or detectors. U.S. Pat. No. 6,486,484 describes pulsed optical couplers which may be utilized in a mouse cursor control device. U.S. Pat. No. 6,626,593 describes a pen printer which may include an optical movement sensor. U.S. Pat. No. 6,850,652 describes an input system including an optical character reader.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a flow diagram in accordance with some embodiments of the present invention.

FIG. 2 is a pictorial diagram in accordance with some embodiments of the present invention.

FIG. 3 is another pictorial diagram in accordance with some embodiments of the present invention.

FIG. 4 is a partially perspective, partially schematic diagram of a system in accordance with some embodiments of the present invention.

FIG. 5 is a block diagram in accordance with some embodiments of the present invention.

FIG. 6 is another block diagram in accordance with some embodiments of the present invention.

FIG. 7 is another block diagram in accordance with some embodiments of the present invention.

FIG. 8 is another block diagram in accordance with some embodiments of the present invention.

FIG. 9 is a block diagram of a method of operation in accordance with some embodiments of the present invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

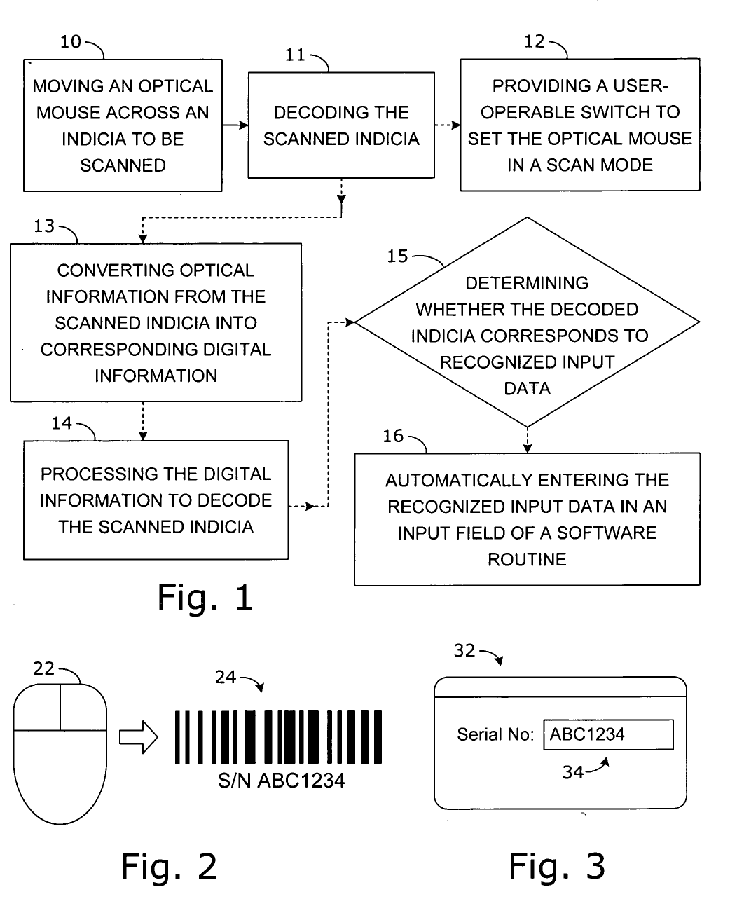

With reference to FIGS. 1-3, some embodiments of the invention may include moving an optical mouse 22 across an indicia 24 (e.g. a barcode) to be scanned (e.g. at block 10) and decoding the scanned indicia (e.g. at block 11). For example, some embodiments of the invention may further include providing a user-operable switch (not shown) to set the optical mouse in a scan mode (e.g. at block 12).

For example, in some embodiments of the invention, decoding the scanned indicia may further include converting optical information from the scanned indicia into corresponding digital information (e.g. at block 13) and processing the digital information to decode the scanned indicia (e.g. at block 14). Some embodiments may further include determining whether the decoded indicia corresponds to recognized input data (e.g. at block 15) and automatically entering the recognized input data in an input field 34 of a software routine 32 (e.g. at block 16). For example, the recognized input data may correspond to at least one of barcode data and character data.

For example, in many work environments, barcodes may be used to organize files, identify products or documents, account for billable hours, and/or organize moderate size lists of categories, among other useful applications for barcodes, while a mouse may be used in the same work environment for traditional mouse input functions. Likewise, text entry is a commonplace task which may be made easier in some situations by the use of an optical character reader. Advantageously, some embodiments of the present invention may simplify a work area by consolidating two or more data input functions into one device.

Another example application involves the integration of computer systems with paper documents using barcodes. For example, an advertisement in a magazine or newspaper may include a barcode for the reader to scan, together with software on the computer that recognizes the decoded information and, for example, brings up a particular website associated with the barcode. Even without a barcode, many advertisements include a relevant website address in text form which may be scanned by an optical character reader. Advantageously, some embodiments of the invention may increase the impact of such advertising by increasing the convenience of having a barcode and/or character reader readily available at the desktop. For example, some embodiments of the invention, by incorporating barcode reading functionality into an optical mouse, may improve the connection between the “real” world of documents and the “virtual” world of the internet, creating new uses and/or usage models for the personal computer.

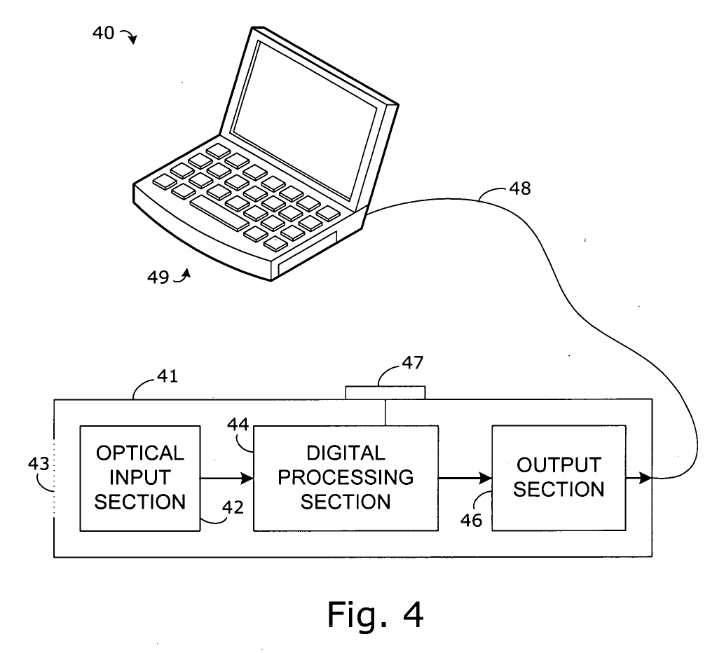

With reference to FIG. 4, a system according to some embodiments of the present invention may include a processor-based system 49 including a software driver, and an optical input device 41 communicatively coupled to the processor-based system 49 (e.g. over communication link 48), wherein the optical input device 41 is configured to convert optical information into digital information, and wherein the software driver is configured to process the digital information from the optical input device 41 to provide at least two data input functions for the optical input device 41.

For example, the optical input device 41 may be configured to provide cursor control data and also data corresponding to scanned indicia. For example, the software driver may be configured to process the data corresponding to scanned indicia to determine if the data corresponds to recognized input data. For example, the recognized input data may correspond to at least one of barcode data and character data. In some embodiments, the software driver may be further configured to provide the recognized input data to another software routine. In some embodiments, at least one of the software driver and the optical input device may include a user-operable switch 47 to set a desired data input function for the optical input device.

In some embodiments, the physical form factor for the optical input device 41 may correspond to a general computer mouse form factor. The mouse shape may be preferred for applications where cursor movement is the predominant input function for the device 41. In some embodiments, the physical form factor for the optical input device 41 may correspond to a general stylus or wand form factor. The wand form factor may be preferred for applications where barcode or optical character reading is the predominant input function for the device 41.

For example, the optical input device 41 may include an optical input section 42 oriented to transmit and receive light signals through an optical window 43. For example, the optical window 43 may simply be one or more openings in the housing of the device 41. Alternatively, the optical window 43 may include a substantially transparent cover, such as clear plastic, a lens, filter, or other optical arrangement. The optical input section 42 may be configured to convert optical information into digital information and to provide the digital information to a digital processing section 44. The digital processing section may perform some processing on the digital information and provide the processed information to an output section 46.

As illustrated, the optional switch 47 may be coupled to the digital processing section 44. Alternatively, the switch 47 may be coupled to or provide signals to any of the input section 42, the processing section 44, and/or the output section 46. In general, the sections 42, 44, and 46 may be configured to be responsive to the switch signal to operate the input device 41 in a desired corresponding mode (e.g. in mouse mode, in barcode reader mode, or in character reader mode). In some embodiments, a physical user-operable switch 47 is optional and the input device 41 may receive operating mode information from the processor-based system 49. Alternatively, the input device 41 may operate in a single mode, and other processing may be performed to distinguish the at least two data input functions.

For example, the processor-based system may comprise a laptop computer 49. The output section 46 provides information from the optical input device 41 to the laptop 49 over a communication link 48. The link 48 may be uni-directional or may be bidirectional. For example, the link 48 may be a wired connection or may be wireless. For example, the optical device 41 and the laptop may both adhere to the Universal Serial Bus (USB) specification and the link 48 may be a USB cable. Alternatively, the output section may provide an RF or infrared wireless signal and the link 48 may correspond to a communication channel at a certain frequency or a certain wavelength of light.

Those skilled in the art will appreciate that techniques for constructing optical input devices such as an optical mouse, an optical barcode reader, an optical character reader, and other optical input devices are well known, and accordingly are not repeated herein. Likewise, techniques for constructing wired links, USB links, and various wireless communication links are well known and not repeated herein.

Those skilled in the art will further appreciate that various functionalities described herein may be distributed between the optical input device 41 and the processor-based system 49. For example, the digital processing section 44 may do little more than pass the digital information along to the output section 46, while the software driver on the processor-based system 49 performs the bulk of the processing required to implement the combined optical input functions. Alternatively, the digital processing section 46 may include sufficient logic and processing power to substantially pre-process the digital information, such that the software driver on the processor-based system 49 is relatively more simple. Of course there are other possible distributions of the implementation of the at least two data input functions.

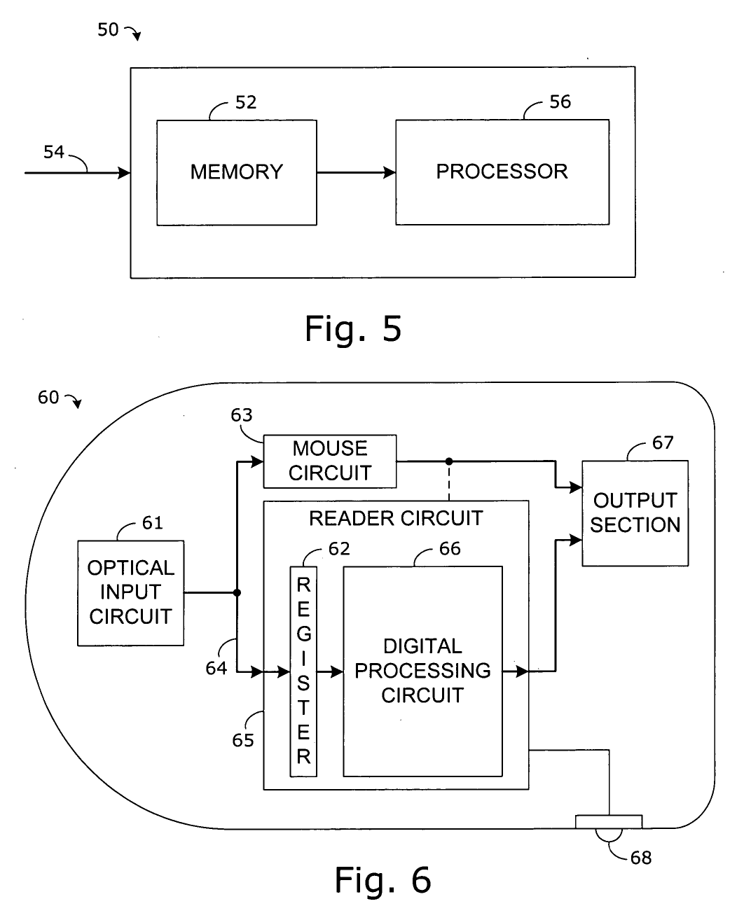

With reference to FIG. 5, a device 50 in accordance with some embodiments of the invention may include a memory circuit (e.g. memory 52) for storing a digital signal 54 derived from one or more optical signals originating from a single input device and a digital processing circuit (e.g. processor 56) configured to process the digital signal 54 to provide at least two data input functions for the single input device. The device 50 may further include a user operable switch to switch the single input device between performing one or another of the at least two data input functions. In some embodiments, the user operable switch may include a software switch on a processor-based system. For example, the software switch may correspond to a check box field or a pull down selection from a software drivers graphical user interface.

For example, the at least two data input functions may include a cursor control data input function and at least one of a barcode data input function and a character input function. In some embodiments, the processor 56 may be adapted to process the digital signal 54 to provide a cursor control data input function and to monitor the cursor control data for recognized input data.

For example, the device 50 may include a personal computer or other processor-based system including the processor 56 and memory 52. For example, the signal 54 may be received by the computer over an industry standard interface, such as the USB interface, the Bluetooth wireless interface, or a WiFi wireless interface. A software driver stored in the memory 52 and executing on the processor 56 may receive the signal 54 and process the information to provide the at least two data input functions.

For example, the signal 54 may comprise the standard digital information provided from an optical mouse and the software driver may use the information to provide a first data input function of cursor control for the personal computer. Those skilled in the art will appreciate that the detailed implementation of a software routine for processing digital information corresponding to cursor control data from, for example, an optical mouse is well known, and accordingly is not repeated herein.

The software driver may save the mouse data in the memory 52 and subsequently process the saved data to identify, for example, valid barcode data, thus providing the second data input function of a barcode reader. Because of the speed of the personal computer, the cursor control and barcode monitoring may appear to be concurrent or simultaneous to a user of the personal computer. If the mouse data is not identified as valid barcode data, the data may be discarded and new data may be loaded. In some embodiments, the saved mouse data may be managed in a shift register or similar memory structure such that the mouse data is examined in portions. In this manner, only a portion of the invalid data is discarded and the shift register may be filled and processed for valid barcode data on a rolling basis. Those skilled in the art will appreciate that the detailed implementation of a software routine for processing digital information corresponding to barcode data from, for example, an optical wand is well known, and accordingly is not repeated herein.

Advantageously, in some embodiments the barcode/character monitoring routine may utilize cursor movement information which may not be available to some wand or stylus type barcode readers. When the user moves the input device across the indicia to be scanned (e.g. in an X direction), the device may not be perfectly parallel to the indicia, thus causing the input optical data to be skewed. Because some embodiments of the invention combine the reading function with a mouse function, cursor movement data may be available to the monitoring routine, including movement data indicating a potentially skewed reading (e.g. cursor movement in the Y direction). For example, the monitoring routine may set a threshold for movement transverse to the scan direction (e.g. the Y direction), and prompt the user to re-scan keeping the device more parallel when the threshold is exceeded. Alternatively, the monitoring routine may utilize the Y movement data to correct for the skew when processing the input data.

With reference to FIG. 6, an optical mouse 60 may include a memory circuit (e.g. register 62) for storing a digital signal 64 derived from one or more optical signals originating from a single input device (e.g. optical mouse 60) and a digital processing circuit (e.g. mouse circuit 63 and reader circuit 65) configured to process the digital signal 64 to provide at least two data input functions for the optical mouse 60. The mouse 60 may further include a user operable switch (not shown) to switch the mouse 60 between performing one or another of the at least two data input functions. For example, the user operable switch may disposed on the mouse 60.

For example, the at least two data input functions may include a cursor control data input function and at least one of a barcode data input function and a character input function. In some embodiments, the mouse circuit 63 may be adapted to process the digital signal 64 to provide a cursor control data input function and the reader circuit 65 may be adapted to monitor the cursor control data for recognized input data. For example, the recognized input data may correspond to at least one of barcode data and character data. In some embodiments, the mouse circuit 63 and reader circuit 65 may both be connected to the same optical input circuit 61 and may both provide their respective outputs to an output section 67.

In some embodiments of the present invention, the optical mouse 60 includes all of the conventional optical mouse circuitry (e.g. input circuit 61, mouse processing circuit 63, and output section 67) together with integrated logic (e.g. reader circuit 65 including digital processing circuit 66) to detect when the mouse 60 is scanning over barcode and/or character data, which may be formatted in accordance with industry standards. For example, the optical mouse 60 may contain one or more light emitting diodes (LEDs) which reflect light off the surface passing underneath the mouse 60 as it is in motion. Advantageously, some embodiments of the invention may use the same optical hardware to simultaneously watch for the known standard markings of barcodes.

For example, when a barcode or character is recognized and successfully scanned, the software driver on a connected computer may notify the user on the computer (or another software routine) and/or may place the decoded information into the input stream as if typed at the keyboard. In some embodiments, the reader circuit 65 may provide a visual and/or audible alert or notification to the user when an indicia has been successfully scanned. In FIG. 6, for example, the reader circuit 65 may be connected to an LED circuit 68, which may be set to illuminate when valid input data is recognized. Alternatively or additionally, in some embodiments, the connected computer may provide a visual alert and/or audible alert, such as a beep and/or pop-up window, when an indicia has been successfully scanned.

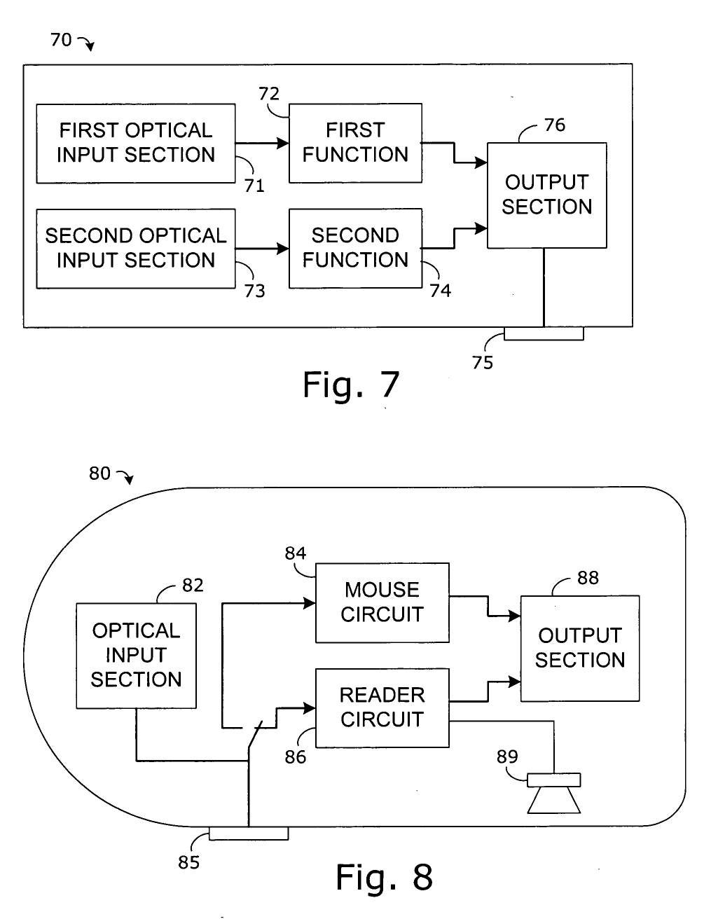

With reference to FIG. 7, an optical input device 70 includes a first optical input section connected to a first function circuit 72. The device 70 further includes a second optical input section 73 connected to a second function 74. For example, the first optical input section 71 and first function circuit 72 may correspond to conventional optical mouse components and circuitry. For example, the second optical input section 73 and second function circuit 74 may correspond to convention barcode reader or optical character reader components and circuitry. In some embodiments, additional optical input sections and function circuit may be included in a single optical input device 70. Each of the first and second functions circuits 72, 74 are respectively connected to an output section 76. An optional user-operable switch 75 may be connected to the output section to selectively set the desired output for the device 70.

For example, the optical input section for a mouse may include an LED and a photodiode. The optical input section for a barcode reader may include a scanning laser and photo-detector circuit. The optical input section for an optical character reader may include a light source and a charge coupled device (CCD) image sensor. For example, a portable optical mouse for a laptop computer may be less than half the size of a typical desktop computer mouse. Miniature barcode laser scanners have been configured as wearable devices that attach to the finger of an operator. Components and circuitry for a stylus or wand type barcode or character reader may fit in a device roughly the size of a ballpoint pen. Those of skill in the art will appreciate that the components and circuits in many conventional optical mice, barcode readers, and optical character reader are quite small and may readily be integrated in a single housing as otherwise separate input and processing modules.

With reference to FIG. 8, an optical input device 80 utilizes a single optical input section 82 to provide optical information to at least two different functional circuits. In some embodiments, various portions of the input section, the processing section, and/or the output section may be shared in order to provide a more economical implementation of an optical input device. For example, some stylus or wand-type barcode and character readers may also utilize an LED and photodiode arrangement (or line of photodiodes). Accordingly, in some embodiments the same optical input section 82 may be utilized to provide the optical information to both a mouse circuit 84 and a reader circuit 86.

In some embodiments, an optional user-operable switch 85 may be used to select between the mouse function and the reader function. Alternatively, in some embodiments the optical information from the input section 82 may be simultaneously provided to both the mouse circuit 84 and the reader circuit 86. Alternatively, in some embodiments the reader circuit 86 may monitor the output of the mouse circuit 84 for valid input data.

Respective outputs from the mouse circuit 84 and the reader circuit 86 may be provided to an output section 88. The reader circuit 86 may optionally be connected to an audio output device 89 (e.g. a speaker), to provide the user with an audible alert when the reader circuit 86 recognizes valid input data. For example, the recognized input data may correspond to at least one of barcode data and character data.

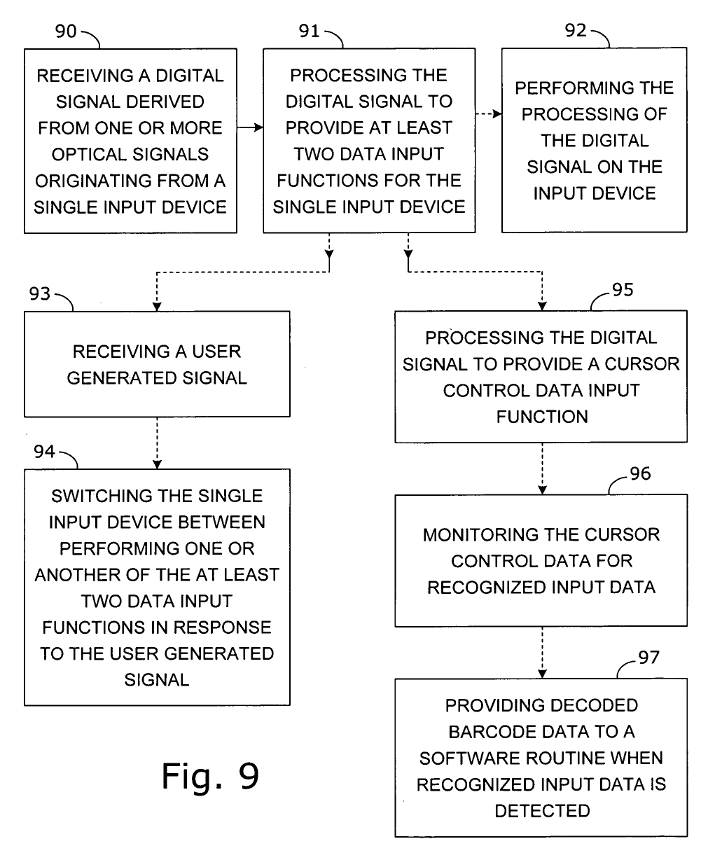

With reference to FIG. 9, some embodiments of the invention may include receiving a digital signal derived from one or more optical signals originating from a single input device (e.g. at block 91) and processing the digital signal to provide at least two data input functions for the single input device (e.g. at block 92). Some embodiments may further include performing the processing of the digital signal on the input device (e.g. at block 92).

For example, some embodiments of the invention may further include receiving a user generated signal (e.g. at block 93) and switching the single input device between performing one or another of the at least two data input functions in response to the user generated signal (e.g. at block 94). Some embodiments may include processing the digital signal to provide a cursor control data input function (e.g. at block 95) and monitoring the cursor control data for recognized input data (e.g. at block 96). For example, the recognized input data may correspond to at least one of barcode data and character data. Some embodiments may further include providing the recognized input data to a software routine when recognized input data is detected in the cursor control data (e.g. at block 97).

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. A method, comprising:
moving an optical mouse across an indicia to be scanned; and
decoding the scanned indicia.

2. The method of claim 1, further comprising:
providing a user-operable switch to set the optical mouse in a scan mode.

3. The method of claim 1, wherein decoding the scanned indicia comprises:
converting optical information from the scanned indicia into corresponding digital information; and
processing the digital information to decode the scanned indicia.

4. The method of claim 3, further comprising:
determining whether the decoded indicia corresponds to recognized input data.

5. The method of claim 4, wherein the recognized input data corresponds to at least one of barcode data and character data.

6. The method of claim 4, further comprising:
automatically entering the recognized input data in an input field of a software routine.

7. A system, comprising:
a processor-based system including a software driver; and
an optical input device communicatively coupled to the processor-based system, wherein the optical input device is configured to convert optical information into digital information,
and wherein the software driver is configured to process the digital information from the optical input device to provide at least two data input functions for the optical input device.

8. The system of claim 7, wherein at least one of the software driver and the optical input device includes a user-operable switch to set a desired input function for the optical input device.

9. The system of claim 7, wherein the optical input device is configured to provide cursor control data and also data corresponding to scanned indicia.

10. The system of claim 9, wherein the software driver is configured to process the data corresponding to scanned indicia to determine if the data corresponds to recognized input data.

11. The system of claim 10, wherein the recognized input data corresponds to at least one of barcode data and character data.

12. The system of claim 10, wherein the software driver is further configured to provide the recognized input data to another software routine.

13. An apparatus, comprising:
a memory circuit for storing a digital signal derived from one or more optical signals originating from a single input device; and
a digital processing circuit configured to process the digital signal to provide at least two data input functions for the single input device.

14. The apparatus of claim 13, further comprising:
a user operable switch to switch the single input device between performing one or another of the at least two data input functions.

15. The apparatus of claim 14, wherein the user operable switch is disposed on the single input device.

16. The apparatus of claim 14, wherein the user operable switch comprises a software switch on a processor-based system.

17. The apparatus of claim 13, wherein the at least two data input functions include a cursor control data input function and at least one of a barcode data input function and a character data input function.

18. The apparatus of claim 17, wherein the second circuit is adapted to process the digital signal to provide a cursor control data input function and to monitor the cursor control data for recognized input data.

19. A method, comprising:
receiving a digital signal derived from one or more optical signals originating from a single input device; and
processing the digital signal to provide at least two data input functions for the single input device.

20. The method of claim 19, further comprising:
performing the processing of the digital signal on the input device.

21. The method of claim 19, further comprising:
receiving a user generated signal; and
switching the single input device between performing one or another of the at least two data input functions in response to the user generated signal.

22. The method of claim 19, further comprising:
processing the digital signal to provide a cursor control data input function; and
monitoring the cursor control data for recognized input data.

24. The method of claim 22, wherein the recognized input data corresponds to at least one of barcode data and character data.

25. The method of claim 22, further comprising:
providing the recognized input data to a software routine when recognized input data is detected in the cursor control data.
